(19) United States
(12) Patent Application Publication
(10) Pub. No.: US 2001/0003827 A1
(43) Pub. Date: Jun. 14, 2001

(54) Method, system and program product for remote maintenance of a peripheral device

(76) Inventor: Akira Shimamura, Yamato-shi (JP)

Correspondence Address: Floyd A. Gonzalez, IBM Corporation - IPLaw, 2455 South Road - MS P386, Poughkeepsie, NY, 12601, US

(21) Appl. No.: 09/732,215

(22) Filed: Dec. 7, 2000

(30) Foreign Application Priority Data
Dec. 10, 1999 (JP) 11-351783

(51) Int. Cl. G06F 15/16

(52) U.S. Cl. 709/206

(57) ABSTRACT

A remote maintenance method to provide a remote maintenance system for LAN connected devices, which enables a maintenance company to maintain devices directly via e-mail communication utilizing device commands and device passwords. The method maintains a device connected to a user side network from a maintenance side management terminal connected to a maintenance side LAN through the Internet.

### TECHNICAL FIELD OF THE INVENTION

The present invention relates to a remote maintenance method for electronic and mechanical devices. Remote maintenance is provided for such devices as printers, copying machines, facsimile units, for example. More particularly, to a technique of remote maintenance for those peripheral devices connected to a network and to be realized with use of the Internet and e-mail.

### BACKGROUND OF THE INVENTION

Remote maintenance and management methods for printers, copying machines, facsimile units, etc. have been well known in the art. For example, Published Unexamined Patent Application No. 8-202509 discloses a printer that sends an error message by e-mail to a predetermined destination if a serious error is detected in the printing block or if the number of not-so-serious errors reaches predetermined error warning level in the printer such that the error is likely to recur. According to the printer disclosed in the patent (No. 8-202509), because the printer is not required to be provided with such an error reporting function as a facsimile transmission function, a voice circuit, etc., the printer can precisely report errors in a simple configuration. In addition, because the printer can predict and report a state in which an error could occur, it has an effect that maintenance and management can be carried out with a margin of safety.

Furthermore, Published Unexamined Patent Application No. 8-115125 discloses a remote maintenance apparatus that can improve the efficiency of maintenance for each of a plurality of such peripheral devices as a printer, a copying machine, a facsimile unit, etc., which are all connected to a system through a network. More precisely, this remote maintenance apparatus creates maintenance information related to an error or usage state of each peripheral device according to its self-test result and sends the maintenance information to a personal computer (hereafter, to be described as a PC) of the user side peripheral device manager by e-mail. Together with the maintenance information, the apparatus also sends by a facsimile service management information to a facsimile unit of the service center. The patent No. 8-115125 describes that the peripheral device manager mentioned above may be a user side manager of the peripheral device, as well as a service center of the object peripheral device.

Furthermore, Published Unexamined Patent Application No. 9-325927 discloses a network remote management system that can carry out remote management of a network in an economical and simple way while assuring the safety of the information in such terminals as printers. More precisely, this network remote management system comprises a remote management apparatus composed of a management company PC, a user side management apparatus composed of a PC, and a user side LAN (Local Area Network) basically. E-mail can be exchanged between the remote management apparatus and the user side management apparatus. The remote management apparatus sends an e-mail including a predetermined command to the user side management apparatus. The user side management apparatus, provided with a protective function for checking received e-mail, checks each e-mail strictly with this protective function, thereby enabling only proper commands to be executed in such peripheral devices as printers, etc. connected to the user side LAN and the result to be sent back from the user side management apparatus to the remote management apparatus.

Furthermore, Published Unexamined Patent Application No. 10-334002 discloses a remote control system that accesses personal files in a network system freely from another network without using any special encryption scheme nor requiring the system manager to set data.

Furthermore, Published Unexamined Patent Application No. 10-207670 discloses a printing system that enables a printer to receive an e-mail created by a computer through a LAN, interpret a control command described in the received e-mail and set various necessary printing conditions according to the control command. This printing system is also provided with functions for reporting the state of the printer, that is, whether the printer is waiting for print data, printing data now, or confronted with an error to the computer by e-mail.

A maintenance contract is often made for such a printer, especially a system printer connected to a host system, between the user company (hereafter, to be referred to the “user”) and the maintenance company in charge of the maintenance of the printer. The maintenance charge in this maintenance contract is varied according to the actual number of sheets to be printed out. Usually, a maintenance charge is set monthly, so the maintenance company sends a service man monthly to the user so as to check the counter value of the number of printed sheets or prints out the counter value. In addition to checking the number of printed sheets, the service man is sent by the maintenance company to the user if the contracted printer goes down (becomes defective). After knowing the error state of the printer, if any replacement parts are needed, the service man arranges to obtain them. Because much time is usually needed to obtain such replacement parts, much more time is taken until the problem is repaired in this case.

In order to solve such a problem, the maintenance company is supposed to prepare means for accessing such a user's printer so as to make remote maintenance. For example, it will be possible for the maintenance company to know such an error state by connecting a modem to the printer and accessing the printer through a telephone line.

However, such a remote maintenance method will also be confronted with the following problems: Because a modem is used, the printer must be connected to a public line. The maintenance company also needs to incure the expense of providing public telephone lines used for the remote maintenance of the printer. This public line is dedicated to the remote maintenance of one printer, so the maintenance company or the user must bear the cost. As many public lines are required as the number of printers if a plurality of printers are installed, thus the expense will become much higher. This is why this remote maintenance method has not been so popular.

On the other hand, because the techniques disclosed in Published Unexamined Patent Application No. 8-202509, No. 8-115125, No. 9-32527 described with reference to the conventional techniques use e-mail respectively, if the object printer is connected to a LAN, it does not require any other public lines. Now that even a system printer is often connected to a LAN, the technique disclosed in Published Unexamined Patent Application No. 8-202509, etc., which use e-mail, is effective.

However, according to the technique disclosed in Published Unexamined Patent Application No. 8-202509, the printer sends an e-mail on its own initiative to a predetermined maintenance company if the printer detects an error, the maintenance company cannot maintain and manage the printer directly.

Furthermore, because the technique disclosed in Published Unexamined Patent Application No. 8-115125 enables the printer to report an error, when it occurs, on its own initiative just like the technique disclosed in Published Unexamined Patent Application No. 8-202509, the maintenance company cannot maintain/manage the printer directly. In addition, according to Published Unexamined Patent Application No. 8-115125, the facsimile unit reports an error to the maintenance company, so the printer must be provided with a facsimile transmission function.

And, because the technique disclosed in Published Unexamined Patent Application No. 9-325927 sends an e-mail to the user from a remote management apparatus (composed of a PC) of the management (maintenance) company, the maintenance company can be seen as managing a printer, etc. directly. However, the technique disclosed in Published Unexamined Patent Application No. 9-325927 certifies each e-mail by the e-mail address of the person authorized to access the e-mail. Usually, an e-mail address is managed by the owner and not available to any other person, so if the person authorized to access the e-mail is out of the maintenance company, nobody else can access the user's printer. And, if there are many persons authorized to access the e-mail, the maintenance company must have a data base to deal with those e-mail. The technique is confronted with inconvenience and extra cost. In addition, while a service man goes out with a portable terminal which e-mail address is different from that of a desk top PC used by himself in the company, it has been impossible to obtain service management information of the user's printer from the portable terminal in an emergency.

Published Unexamined Patent Application No. 10-334002 does not disclose any technique related to the service management of peripheral devices.

Furthermore, Published Unexamined Patent Application No. 10-207670 proposes that the maintenance of the printer is basically done within the user's LAN and it is not expected to exchange e-mail between the maintenance company and the printer.

### SUMMARY OF THE INVENTION

It is an object of the present invention to provide a remote management system for peripheral devices, which can solve such conventional problems and enable a maintenance company to maintain and manage contracted printers directly, as well as eliminating the cost of providing telephone lines to each device.

It is another object of the present invention to provide a remote maintenance system that requires no certification of e-mail by e-mail addresses authorized to access peripheral devices. It is still another object of the present invention to provide a remote maintenance system used to operate such a remote maintenance system, a peripheral device processing apparatus, and a maintenance method for printers.

In order to solve the above problems, the present inventor proposes the use of e-mail. This is because many users have peripherals attached to LANs and they can make use of e-mail via the LAN and the Internet, so that maintenance companies can access peripheral devices of those users via of e-mail easily. That is, it is possible to make service management of those peripheral devices directly.

Although Published Unexamined Patent Application No. 9-325927 discloses a method for using e-mail for such a remote management system, the method has been confronted with a problem that if a person authorized to access e-mail is out of the maintenance company, no other persons can access the user's printer. In order to solve such a problem, the present invention assigns a password to each peripheral device, thereby judging whether or not the peripheral device has a maintenance command related to an object maintenance job and it is authorized to execute the command. If the maintenance company knows both command and password for each peripheral device, the serviceman can access the peripheral device easily even from outside the maintenance company.

The maintenance system of the present invention is used at user's side and is provided with peripheral devices used to execute necessary functions through a connected personal computer and a mail server. The maintenance system of the present invention can be connected to a maintenance side network provided with a maintenance side terminal through the Internet. And, an e-mail address is assigned to each peripheral device of the user's side network and the mail server is provided with an e-mail receiver for receiving e-mail from the mail server, a command analyzer for checking the validity of the commands provided in the e-mail received by the e-mail receiver, and a password analyzer for checking the password provided in the e-mail for authorization to execute the command when the command analyzer decides it possible to interpret the command.

According to the maintenance system described above, because the user side network is provided with a mail server and an e-mail address is assigned to the peripheral device, the maintenance side management terminal can be used for direct maintenance of the peripheral device with use of e-mail. In addition, because the e-mail address authorized to access the peripheral device is not used to certify those e-mail, it is possible to solve the conventional problem that the user's printer cannot be accessed while a person authorized to access the e-mail in the maintenance company is unavailable.

Furthermore, the maintenance system is further provided with a command analyzer for checking its own ability to interpret the command described in an e-mail received by the e-mail receiver and a password analyzer for checking a password described in the e-mail for authorization to execute the command when the command analyzer decides the command is valid. Consequently, even while the e-mail address of the object peripheral device is known by external persons other than the service man, it is not easy for the external person to access the peripheral device since a password is required.

The peripheral device mentioned above is a device connected to a personal computer and used to realize a necessary function. For example, it may be a printer, a facsimile unit, a copying machine, or a scanner. In the maintenance system of the present invention, the mail server may be separate from the peripheral device or may be built in the peripheral device.

In the maintenance system of the present invention, the user side network peripheral device may be provided with a command executor for executing a command if the password analyzer decides that the object password is authorizes the device to execute the command. Consequently, the peripheral device itself can execute the command according to the decision of the password analyzer.

Furthermore, in the maintenance system of the present invention, the user side network peripheral device can also be provided with an e-mail transmitter for creating e-mail text including the result of a command execution by the command executor and transmitting the e-mail text to the object address through the mail server. Consequently, the peripheral device itself can transmit the e-mail to the maintenance side according to the result of the command execution by the command executor.

Furthermore, in the maintenance system of the present invention, the e-mail receiver can check the mail server for arrival of e-mail periodically. For example, the e-mail receiver can check the mail server for arrival of e-mail according to an instruction from the user, but the user might forget such an instruction sometimes, thereby no proper response will be sent back in response to an access from the maintenance side. If the e-mail receiver checks the mail server for arrival of e-mail periodically, for example, every minute, the e-mail receiver will be able to respond to an access from the maintenance side more quickly.

Using the maintenance system of the present invention as described above will thus make it possible to carry out the following remote maintenance method of the present invention. The remote maintenance method of the present invention is employed for carrying out remote maintenance of a peripheral device from a maintenance side terminal through the Internet. The peripheral device is connected to a network and a computer of the user side so as to perform necessary functions. An e-mail address is assigned to the peripheral device beforehand.

Such a remote maintenance method of the present invention comprises the following steps;

a first transmission step for transmitting a first e-mail describing a command predetermined according to a maintenance type to an e-mail address assigned to the peripheral device to accept maintenance from a maintenance side management terminal;

a receiving step for enabling the user side peripheral device to receive the first e-mail;

an authorization checking step for checking if the peripheral device is authorized to execute the command described in the received first e-mail;

a command execution step for executing a command when the peripheral device is authorized to execute the command in the authorization step;

a mail creating step for creating second e-mail text including a result of command execution from the command execution step;

and a second transmission step for transmitting the second e-mail text created in the mail creating step to the e-mail address of the source of the first e-mail transmitted in the first transmission step.

In the remote maintenance method of the present invention described above, the mail transmission step is not only for transmitting an e-mail from the maintenance company. For example, a serviceman of the company can also transmit an e-mail from outside the company with use of a portable terminal. A maintenance activity carried out from a maintenance side terminal also includes such transmission of e-mail.

In the remote maintenance method of the present invention described above, a command can be used to obtain an error log of a peripheral device. For example, if the maintenance company is reported by a user by telephone about an error detected in a printer, the maintenance side serviceman transmits an e-mail describing a command to obtain the error log to the user. The serviceman can use the error log information to order parts that may be needed to repair the problem. Consequently, the serviceman can bring the ordered parts when he carries out the maintenance for the peripheral device. In addition, although user's manual reports often include wrong information, the error log obtained electronically, by the serviceman, will be more accurate. In addition, because such an error log also includes error history information, the serviceman will be able to know the error tendency of the printer, thereby the serviceman can reflect the error tendency in the maintenance work.

In addition to a case when the user reports errors, the serviceman can also transmit e-mail periodically to the user. For example, according to the present invention, the serviceman can transmit a command by an e-mail to obtain the number of sheets printed out by the printer. In this case, however, the serviceman is just required to transmit an e-mail periodically such as once a month.

According to the present invention, therefore, it is possible to obtain information including an error log without printing it out, so the user is not interrupted. In addition, although a printer might go down with the printing mechanism most frequently, the present invention enables various types of information to be obtained even when the mechanical printing mechanism is down.

According to the remote maintenance method of the present invention, the user side network includes a mail server and e-mail from the maintenance side management terminal are stored in this mail server. In the mail receiving step, the peripheral device accesses the mail server so as to receive the stored e-mail. The access to the mail server may be periodical.

In the remote maintenance method of the present invention, the mail transmission step may either send an e-mail back to the e-mail address of the source of the e-mail transmitted in the mail transmission step. Alternatively, the e-mail may be sent to an e-mail address specified by the e-mail transmitted in the mail transmission step.

The present invention also proposes the following peripheral device processing apparatus employable for the remote maintenance system and the remote maintenance method described above.

The peripheral device processing apparatus of the present invention comprises an e-mail transmitter/receiver for transmitting and receiving e-mail related to the maintenance thereof;

a command memory for storing maintenance commands executable by the apparatus itself;

and a password memory for storing a password for checking for authorization to execute a maintenance command.

The peripheral device processing apparatus can also be provided with a command analyzer for checking if any command stored in the command memory matches with the command described in the e-mail.

In addition, the apparatus can further be provided with a password analyzer for checking if any password stored in the password memory matches with the password described in the e-mail.

If the command analyzer decides that the object e-mail describes a command matching a command stored in the command memory and the password analyzer decides that the e-mail describes a password matching a password stored in the password memory, the command is executed. The peripheral device processing apparatus, if provided with a command executor for executing a maintenance command as described above, can execute the command by itself. After the command execution, the e-mail transmitter/receiver may create e-mail text including the result of the command execution and transmit the e-mail text to the object address.

The peripheral device processing apparatus may be a printer, a facsimile unit or the like. Now that communications through LAN and Internet are common, such a printer is often connected to a LAN and the Internet. Consequently, the use of the peripheral device processing apparatus of the present invention eliminate the expense of additional telephone lines per device.

According to the present invention, the remote maintenance method is characterized in that the method is applied to a printer connected to a user side network from the maintenance side management terminal connected to the maintenance side network through the Internet. An e-mail address is assigned to the printer and the maintenance side management terminal transmits an e-mail describing a command predetermined according to a maintenance type to the e-mail address. The e-mail is stored in the mail server connected to the user side network. The printer, after reading the e-mail stored in the mail server, decides whether to execute the command according to the information described in the e-mail.

In this remote maintenance method for the printer, the command (predetermined according to a maintenance type) may be a command for obtaining trace information related to the firmware of the printer. The firmware mentioned here means a program required to control the hardware of the printer. For a printer, it means a program required to control the printing mechanism and other portions thereof. Usually, the operation of this firmware (the trace information) is recorded. Errors of the firmware can thus be analyzed by obtaining this trace information. The command predetermined according to a maintenance type may also be a command for obtaining information related to updating of the printer firmware and the result of the updating.

These and other objects will be apparent to one skilled in the art from the following drawings and detailed description of the invention.

### BRIEF DESCRIPTION OF THE DRAWINGS

FIG. 1 is a block diagram of an example remote maintenance system of the present invention;

FIG. 2 is a block diagram of a printer 303 of the remote maintenance system of the present invention;;

FIG. 3 is a block diagram of an example maintenance portion of the present invention;

FIG. 4 is an example of e-mail text created by a service man of the present invention;

FIG. 5 is an example of e-mail text printed out by a printer 303 of the present invention;

FIG. 6 is a flow chart of the processing of the printer 303 of the present invention;

FIG. 7 is another example of e-mail text created by a service man in the present invention;

FIG. 8 is an example of e-mail text printed out by the printer 303 in response to the e-mail text shown in FIG. 7;

FIG. 9 is another example e-mail text created by a service man of the present invention; and

FIG. 10 is an example of e-mail text printed out by the printer 303 in response to the e-mail text shown in FIG. 9.

### DESCRIPTION OF THE PREFERRED EMBODIMENT

Hereunder, the present invention will be described on the basis of an embodiment.

Description of symbols used herein:

1 . . . Maintenance Company

2 . . . Internet

3 . . . User

101 . . . Management Terminal (PC)

102, 302 . . . Mail Server

103, 304 . . . LAN

104, 301 . . . Gate Way/Fire Wall

303 . . . Printer

305 . . . Host System

401 . . . e-mail Transmitter/Receiver

402 . . . Command Analyzer

403 . . . Password Analyzer

404 . . . Command Executor

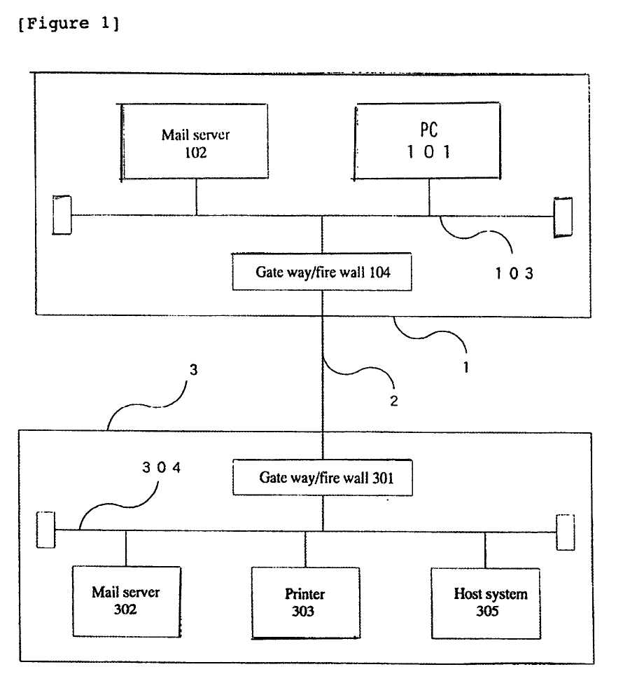

FIG. 1 is a block diagram of a remote maintenance system of the present invention. As shown in FIG. 1, the remote maintenance system comprises a maintenance company 1, the Internet 2 and a user 3.

The maintenance company 1 is provided with a LAN 103. The LAN 103 is connected to a management terminal (PC) 101 composed of a personal computer with which a serviceman can transmit e-mail and a mail server 102 for sending/receiving e-mail to/from the maintenance company 1. The maintenance company 1 is also provided with a gate way or fire wall 104 (hereafter, to be referred to as a gate way 104 generically) for connecting the LAN 103 of the maintenance company 1 to the Internet 2.

Alternatively, the user 3 is provided with a gate way or fire wall 301 (hereafter, to be referred to as a gate way 301 generically) for connecting the LAN 304 of the user 3 to the Internet 2. The LAN 304 is connected to a mail server 302 for sending/receiving e-mail to/from the user company, a printer 303, and a host system 305 for sending data to the printer 303. An e-mail address prt03@zzz.co.jp is assigned to the printer 303.

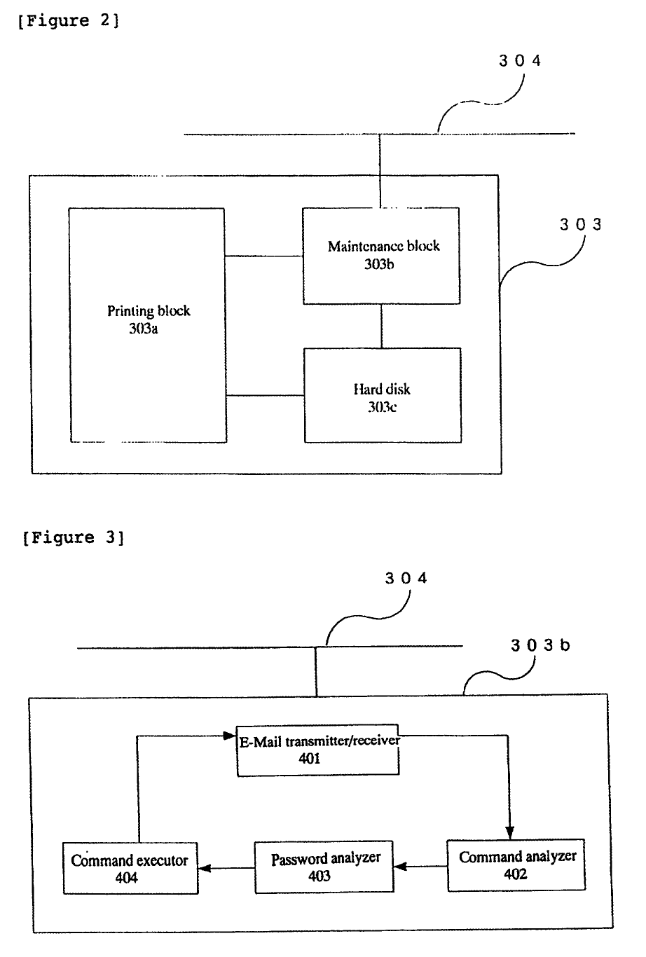

FIG. 2 is a schematic block diagram of the printer 303. More precisely, the printer 303 is composed of a printing block 303a, a maintenance block 303b, and a hard disk 303c, which is used as a recording medium.

The printing block 303a is a core portion of the printer 303 and comprises the printing mechanism. The configuration of the printing block 303a is the same as that of the conventional well-known one. The maintenance block 303b is newly added by the present invention and the configuration is as shown in FIG. 3. The hard disk 303c stores the firmware for controlling the printing block 303a, the hardware trace information, font data, an error log, and received e-mail, etc.

FIG. 3 is a block diagram of the maintenance block 303b. The maintenance block 303b includes an e-mail transmitter/receiver 401, a command analyzer 402, a password analyzer 403, and a command executor 404.

The e-mail transmitter/receiver 401 sends/receives e-mail through the mail server 302. To receive e-mail, the e-mail transmitter/receiver 401 accesses the mail server 302 periodically, for example, every minute. To transmit e-mail, the command executor 404 creates e-mail text so as to include the result of command execution by the command executor 404 and transmits the e-mail text to the mail server 302. In this embodiment, the e-mail transmitter/receiver 401 is described as a single unit, but the transmitter and the receiver may be separated. According to the remote maintenance method of the present invention, the transmitter and the receiver can be united or separated.

The command analyzer 402 decides if the printer 303 can interpret (that is, execute) the command described in the received e-mail. More precisely, the command analyzer 402 enables the printer 303 to decide if any maintenance command stored in itself matches with the command described in the received e-mail. In this embodiment, the maintenance command is stored in the hard disk 303c, but the storage of the command may not be limited only to that.

The password analyzer 403 executes it's function if the command analyzer 402 decides that any stored maintenance command matches with the command described in the received e-mail. More precisely, the printer 303 stores a password for authorizing the execution of the maintenance command beforehand and checks if this password matches with the password described in the received e-mail. In this embodiment, the password is stored in the hard disk 303c, but the storage of the password may not be limited to that in general.

The command executor 404 executes maintenance commands. For a command for obtaining information related to an error log, the command executor 404 reads the error log information from the hard disk 303c. Then, the command executor 404 transfers the information to the e-mail transmitter/receiver 401.

The following is an example of a maintenance system method that uses the remote maintenance system as described above.

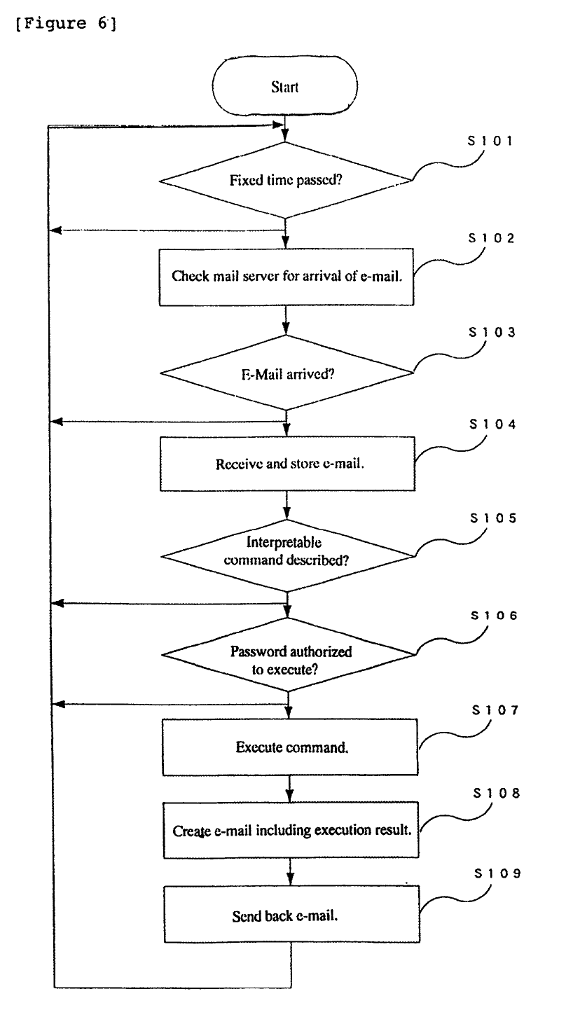

FIG. 6 shows a flow chart for a series of processes executed in the printer 303. At first, the outline of the processes executed in the printer 303 will be described with reference to FIG. 6.

The e-mail transmitter/receiver 401 of the printer 303 checks if a predetermined time has passed (S101). If the time has passed (YES), the mail server 302 is checked for arrival of e-mail (S102). The transmitter/receiver 401 accesses the mail server 302 periodically so as to check arrival of e-mail. Then, the transmitter/receiver 401 checks arrival of e-mail (S103). If any e-mail arrives, the transmitter/receiver 401 receives the mail and stores it in the hard disk 303c (S104). After that, the command analyzer 402 checks the stored e-mail text for description of a valid command, that is, a maintenance command executable by the printer 303 (S105). If such a command is described in the e-mail, the password analyzer 403 checks the mail text for description of a password authorized to execute the command (S106). If the password is described (YES), the command executor 404 executes a job specified by the command (S107). After that, the e-mail transmitter/receiver creates e-mail text including the result of the command execution (S108) and sends back the e-mail text to a service person of the transmitter (S109).

Hereunder, an example will be made more precisely for the remote maintenance method in this embodiment (see FIGS. 1 through 5).

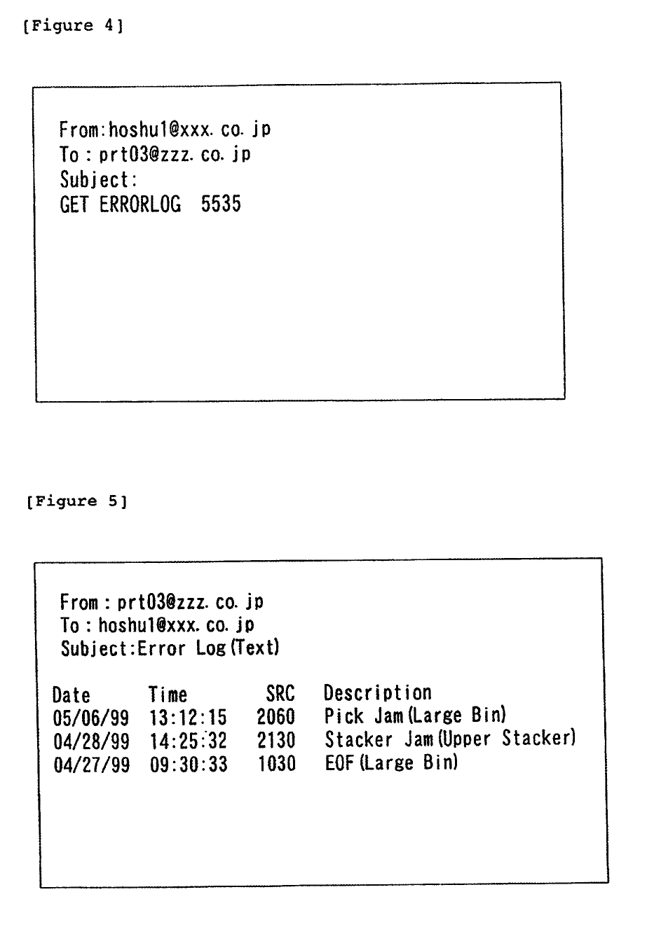

A service man of the maintenance company 1 creates an e-mail to be addressed to the printer 303 provided in the PC 101 so as to obtain necessary maintenance information from the printer 303. The e-mail includes a command and a password predetermined so as to enable the printer 303 to interpret them. FIG. 4 shows an example of such a process. In this example, the e-mail includes a command for instructing the printer 303 assigned with an e-mail address prt03@zzz.co.jp to send back its error log. In FIG. 4, GET ERRORLOG is the command and 5335 following the command is a password.

When the serviceman sends the e-mail, the e-mail is transmitted outside the maintenance company 1 through the mail server 102 connected to the LAN 103. The mail is then delivered to the mail server 302 through the gate way 104, the Internet 2, and the gate way 301 of the user company. The printer 303 connected to the LAN 304 is provided with a function for receiving the e-mail, so that the e-mail transmitter/receiver 401 of the printer 303 checks the mail server for arrival of e-mail periodically so as to open them at the printer 303.

If any e-mail arrives, the e-mail transmitter/receiver 401 receives and stores the e-mail in the hard disk 303c. Then, the command analyzer 402 of the printer 303 checks the content of the e-mail, then checks the e-mail for description of a command, that is, GET ERRORLOG executable by itself. This check is made by checking if any maintenance command stored in the hard disk 303c matches with the command described in the received e-mail. In this embodiment, a check is performed to see if any maintenance command stored in the hard disk 303c matches with GET ERRORLOG. If the hard disk 303c stores no command matching with the command described in the received e-mail, that is, if no command that the printer can interpret is described in the received e-mail, the printer ignores the e-mail.

If the e-mail describes a command that the printer 303 can interpret, the password analyzer 403 of the printer 303 checks the password (5535 in this embodiment) described in the e-mail for authorization to execute the GET ERRORLOG command. This check is made by checking if a password stored in the hard disk 303c matches the password described in the received e-mail. In this embodiment, the passwords stored in the hard disk 303c are checked to see if they match 5535. If any command stored in the hard disk 303c matches 5535, the password analyzer 403 checks the password for authorization to execute the GET ERRORLOG command, so that the command executor 404 executes the GET ERRORLOG command. If no password stored in the hard disk 303c matches the password described in the received e-mail, that is, if it cannot be confirmed by the password if the printer 303 is authorized to execute the command, then the command executor 404 ignores the e-mail.

The command executor 404 collects GET ERRORLOG, that is, the error information within a predetermined period. Then, the e-mail transmitter/receiver 401 creates e-mail text including collected error information, that is, the result of the GET ERRORLOG execution.

FIG. 5 shows an example of the created e-mail text. In this example, the error log information consists of a date, a time, an error code (SRC), and an error type (description). Pick Jam and Stacker Jam indicate occurrence of a paper jam respectively. EOF indicates that the print paper is used up.

The created e-mail is then transmitted by the e-mail transmitter/receiver 401 to the e-mail address hoshul@xxx.co.jp in the maintenance company 1 through the mail server 302 connected to the LAN 304. The sent-back e-mail is delivered to the mail server 102 in the maintenance company 1 through the gate way 301 and the Internet 2.

A serviceman of the maintenance company 1 checks arrival of e-mail to the company 1 periodically. Through this check of e-mail arrival, the serviceman can obtain his necessary error log information. The error log shown in FIG. 5 makes it possible to include not only the currently occurred error, but also errors in the past (error history). The error log is thus very useful for maintenance.

Usually, the serviceman prints out error log information with use of the printer 303 when he arrives in the user's company so as to know the states of generated errors in the printer according to the printed-out information. If any parts must be replaced to repair the device, the service man arranges obtaining of the parts. Consequently, much time is needed until the service man completes the maintenance with those obtained replacement parts. In addition, if the printer 303 is disabled for operation due to an error occurring in the printing mechanism, the service man will not be able to print out the error log to know how errors have been generated.

Under such circumstances, according to this embodiment, because the service man can obtain such an error log from the maintenance company 1, the service man can arrange obtaining of necessary replacement parts before he goes to the user's company. In addition, even when the printer 303 is disabled for operation, he can know how errors have been generated. Furthermore, because the service man even knows how errors have been generated in the printer in the past, he can maintain and check the printer with reference to those error histories. Such an error log will thus be very useful to prevent the printer 303 from recurrence of similar errors. In addition, because the printer 303 is not required to print out the error log, the maintenance will not disturb the user 3, who is operating the printer 303.

Although a description is made for how to obtain an error log in the above embodiment, the present invention is not limited only to that; the above embodiment is also effective to obtain information related to the number of sheets to be printed out by the printer 303. For example, it is possible to obtain the information related to the total number of sheets monthly for each paper size. And, according to this information, the maintenance company 1 can calculate the service payment to be charged to the user 3 and let the user 3 know the tendency of frequently used paper sizes.

Furthermore, if firmware trace information is stored in the hard disk 303c, the above embodiment can be employed to obtain the trace information. The trace information also records errors that occurred in the firmware. Consequently, such obtained trace information can be employed to improve the firmware. According to the present invention, for example, even when the developer of the firmware lives in a foreign country, the developer can obtain such trace information quickly.

Furthermore, the present invention can also apply to updating of the firmware to eliminate future occurrences of the error detected in the past. More precisely, it is possible to attach the object firmware to the e-mail, support the updating of the firmware in the printer 303 and send back the information of the effect with an e-mail after the updating is finished.

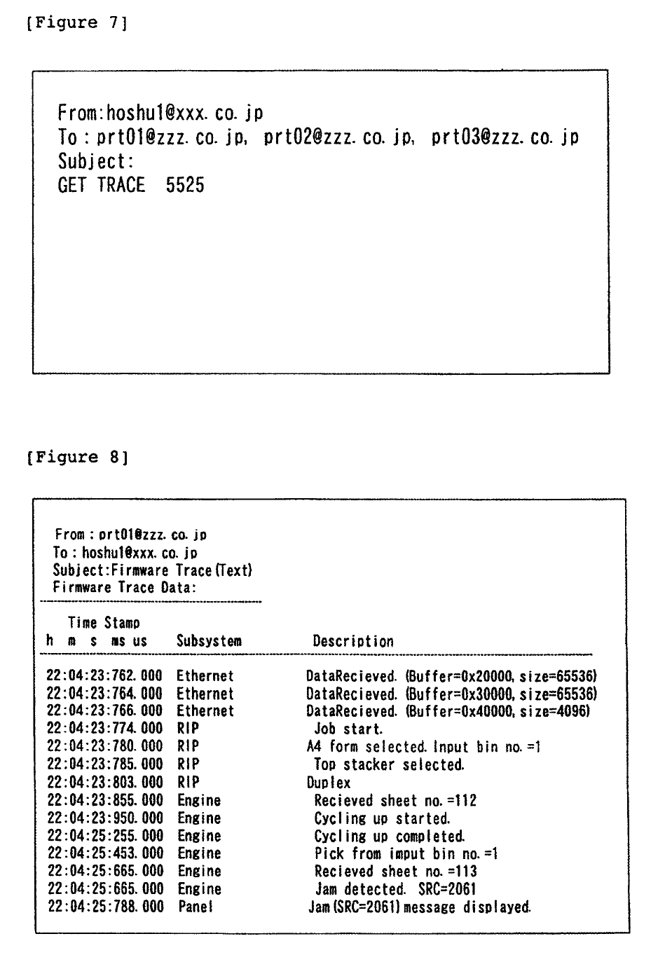

Even in the above case, a command and a password are predetermined and registered in the printer 303, so that the processing can be executed similar to that in the above embodiment. For example, it is only required that a command GET FIRMWARE TRACE to obtain the firmware trace information and a password 5525 authorized to execute the command are predetermined and stored in the printer 303 as shown in FIG. 7. FIG. 8 shows e-mail text sent back in response to the e-mail shown in FIG. 7. This e-mail describes trace information, so the firmware can be improved by analyzing this trace information. In the example shown in FIG. 7, three printers of the addresses prt01@zzz.co.jp, prt02@zzz.co.jp, and prt03@zzz.co.jp are specified as the destinations of the e-mail. According to the present invention, therefore, it is possible to transmit an e-mail to a plurality of printers so as to quickly obtain the information from each printer.

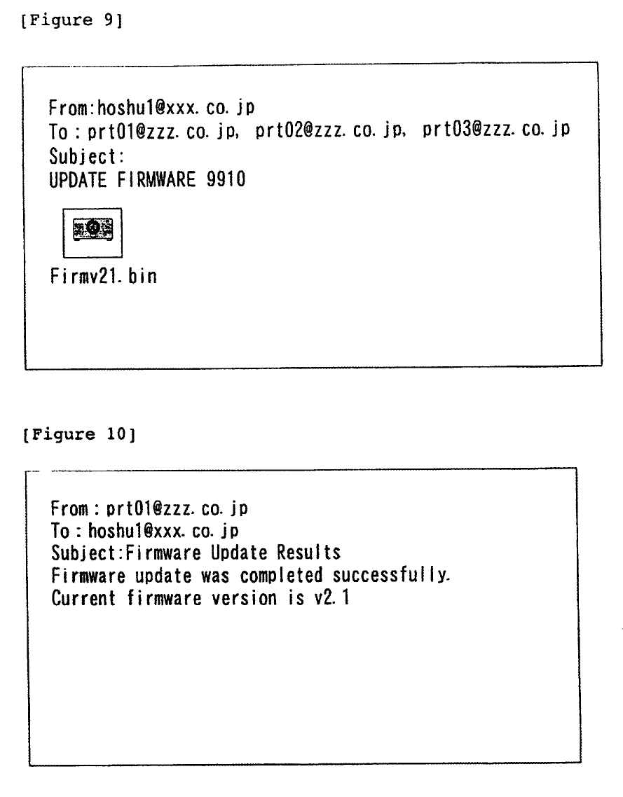

Furthermore, as shown in FIG. 9, it is also possible to predefine UPDATE FIRMWARE as a command used to update the object firmware and obtain the result of the updating and 9910 as a password authorized to execute the command and store them in the printer 303. FIG. 10 shows e-mail text to be sent back in response to this e-mail. The e-mail describes both completion of the firmware updating and addition of the firmware version information.

As described above, according to the present invention, a maintenance company can maintain printers directly and it is not required to make any additional construction such as telephone line laying. It is also possible to obtain a remote maintenance system free of certification of e-mail, since it uses an e-mail address authorized to access each peripheral device. In addition, the present invention can provide a remote maintenance system to execute such a remote maintenance system, a peripheral device processing apparatus, and a maintenance method for printers.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for maintaining and servicing a device from one of one or more remote maintenance terminals through the Internet said method comprising the steps of:
a) receiving at said device a first message from one of said one or more remote maintenance terminals wherein said first message includes a first command and a first authorizing message;
b) checking said first authorizing message for validity; and
c) executing said first command if said first authorizing message is valid for said device.

2. The method for maintaining and servicing a device according to claim 1 further including the steps of:
d) receiving said first message at a server; and
e) relaying said first message from said server to said device.

3. The method for maintaining and servicing a device according to claim 1 wherein said authorizing message is a password.

4. The method for maintaining and servicing a device according to claim 1 including a further step of transmitting a second message from said device to one of one or more remote maintenance terminals.

5. The method for maintaining and servicing a device according to claim 4 further including the steps of:
d′) obtaining information about said executing said first command step; and
e′) including said information obtained into said second message.

6. The method for maintaining and servicing a device according to claim 1 wherein said first command is a request to obtain an error log of said peripheral device.

7. The method for maintaining and servicing a device according to claim 4 wherein said second message is created in said device according to information received in said first message.

8. The method for maintaining and servicing a device according to claim 1 wherein said first message includes firmware to be loaded into said first device firmware memory.

9. The method for maintaining and servicing a device according to claim 4 wherein said second message includes device specific information requested by said first command.

10. The method for maintaining and servicing a device according to claim 4 wherein said second message includes trace information from said device.

11. The method for maintaining and servicing a device according to claim 1 wherein said device includes a printing device.

12. The method for maintaining and servicing a device according to claim 2 comprising the further step of:
f) checking said server at predetermined intervals for existing first messages,
g) transmitting one of said existing first messages to said device.

13. The method for maintaining and servicing a device according to claim 4 wherein said second message is created in said device according to information received in said first message.

14. The method for maintaining and servicing a device according to claim 4 wherein said second message includes device specific information requested by said first command.

15. The method for maintaining and servicing a device according to claim 4 wherein said second message includes trace information from said device.

16. The method for maintaining and servicing a device according to claim 1 comprising the further step of transmitting said first message from said one or more remote maintenance terminals.

17. A system for maintaining and servicing a device from one of one or more remote maintenance terminals through the Internet said method comprising:
a) means for receiving at said device a first message from one of said one or more remote maintenance terminals wherein said first message includes a first command and a first authorizing message;
b) means for checking said first authorizing message for validity; and
c) means for executing said first command if said first authorizing message is valid for said device.

18. The system for maintaining and servicing a device according to claim 17 further including:
d) means for receiving said first message at a server; and
e) means for relaying said first message from said server to said device.

19. The system for maintaining and servicing a device according to claim 17 wherein said authorizing message is a password.

20. The system for maintaining and servicing a device according to claim 17 including a further step of transmitting a second message from said device to one of one or more remote maintenance terminals.

21. The system for maintaining and servicing a device according to claim 20 further including:
d′) means for obtaining information about said executing said first command step; and
e′) means for including said information obtained into said second message.

22. The system for maintaining and servicing a device according to claim 17 wherein said first command is a request to obtain an error log of said peripheral device.

23. The system for maintaining and servicing a device according to claim 20 wherein said second message is created in said device according to information received in said first message.

24. The system for maintaining and servicing a device according to claim 17 wherein said first message includes firmware to be loaded into said first device firmware memory.

25. The system for maintaining and servicing a device according to claim 20 wherein said second message includes device specific information requested by said first command.

26. The system for maintaining and servicing a device according to claim 20 wherein said second message includes trace information from said device.

27. The system for maintaining and servicing a device according to claim 17 wherein said device includes a printing device.

28. The system for maintaining and servicing a device according to claim 18 further comprising:
f) means for checking said server at predetermined intervals for existing first messages,
g) means for transmitting one of said existing first messages to said device.

29. The system for maintaining and servicing a device according to claim 20 wherein said second message is created in said device according to information received in said first message.

30. The system for maintaining and servicing a device according to claim 20 wherein said second message includes device specific information requested by said first command.

31. The system for maintaining and servicing a device according to claim 20 wherein said second message includes trace information from said device.

32. The system for maintaining and servicing a device according to claim 17 comprising means for transmitting said first message from said one or more remote maintenance terminals.

33. A computer program product comprising a computer useable medium having computer readable program code means therein for maintaining and servicing a device from one of one or more remote maintenance terminals through the Internet said computer program product comprising:
a) computer readable program code means for receiving a first message at said device from one of said one or more remote maintenance terminals wherein said first message includes a first command and a first authorizing message;
b) computer readable program code means for checking said first authorizing message for validity; and
c) computer readable program code means for executing said first command if said first authorizing message is valid for said device.

34. The computer program product for maintaining and servicing a device according to claim 33 further comprising:
d) computer readable program code means for receiving said first message at a server; and
e) computer readable program code means for relaying said first message from said server to said device.

35. The computer program product for maintaining and servicing a device according to claim 33 wherein said authorizing message is a password.

36. The computer program product for maintaining and servicing a device according to claim 33 further comprising computer readable program code means for transmitting a second message from said device to one of one or more remote maintenance terminals.

37. The computer program product for maintaining and servicing a device according to claim 36 further comprising:
d′) computer readable program code means for obtaining information about said executing said first command step; and
e′) computer readable program code means for including said information obtained into said second message.

38. The computer program product for maintaining and servicing a device according to claim 33 wherein said first command is a request to obtain an error log of said peripheral device.

39. The computer program product for maintaining and servicing a device according to claim 36 wherein said second message is created in said device according to information received in said first message.

40. The computer program product for maintaining and servicing a device according to claim 33 wherein said first message includes firmware to be loaded into said first device firmware memory.

41. The computer program product for maintaining and servicing a device according to claim 36 wherein said second message includes device specific information requested by said first command.

42. The computer program product for maintaining and servicing a device according to claim 36 wherein said second message includes trace information from said device.

43. The computer program product for maintaining and servicing a device according to claim 33 wherein said device includes a printing device.

44. The computer program product for maintaining and servicing a device according to claim 34 further comprising:
f) computer readable program code means for checking said server at predetermined intervals for existing first messages,
g) computer readable program code means for transmitting one of said existing first messages to said device.

45. The computer program product for maintaining and servicing a device according to claim 36 wherein said second message is created in said device according to information received in said first message.

46. The computer program product for maintaining and servicing a device according to claim 36 wherein said second message includes device specific information requested by said first command.

47. The computer program product for maintaining and servicing a device according to claim 36 wherein said second message includes trace information from said device.

48. The computer program product for maintaining and servicing a device according to claim 33 further comprising computer readable program means for transmitting said first message from said one or more remote maintenance terminals.
